(19) United States
(12) Patent Application Publication
(10) Pub. No.: US 2008/0181831 A1
(43) Pub. Date: Jul. 31, 2008

(54) SHEET MEMBER AND MANUFACTURING METHOD THEREOF, EXHAUST GAS TREATING APPARATUS AND MANUFACTURING METHOD THEREOF, AND SILENCING DEVICE

(75) Inventor: Takahiko Okabe, Ogaki-Shi (JP)

Correspondence Address: DITTHAVONG MORI & STEINER, P.C., 918 Prince St., Alexandria, VA, 22314, US

(73) Assignee: IBIDEN CO., LTD., Ogaki (JP)

(21) Appl. No.: 12/020,179

(22) Filed: Jan. 25, 2008

(30) Foreign Application Priority Data
Jan. 26, 2007 (JP) 2007-016772
Dec. 3, 2007 (JP) 2007-312694

(51) Int. Cl. B01D 53/86; B32B 7/04; B32B 37/00; B32B 38/00; F01N 1/24; B21D 51/16; D21J 3/00; B01D 35/00

(52) U.S. Cl. 422/177; 428/119; 156/60; 162/219; 55/502; 156/184; 29/890.08; 181/256

(57) ABSTRACT

A sheet member includes inorganic fiber; and a first surface and a second surface that are substantially perpendicular with respect to a thickness direction of the sheet member. The first surface includes a first sheet portion having a first volume density. The second surface includes a second sheet portion having a second volume density that is higher than the first volume density.

### CROSS-REFERENCE TO RELATED APPLICATIONS

The present application claims priority under 35 U.S.C. §119 to Japanese Patent Application No. 2007-016772 filed on Jan. 26, 2007 and Japanese Patent Application No. 2007-312694 filed on Dec. 3, 2007. The contents of these applications are incorporated herein by reference in their entirety.

### BACKGROUND OF THE INVENTION

1. Field of the Invention

The present invention relates to a sheet member, a manufacturing method thereof, an exhaust gas treating apparatus, a manufacturing method thereof, and a silencing device including the sheet member.

2. Discussion of the Background

The number of automobiles has been rapidly increasing since the beginning of this century. Accordingly, the amount of exhaust gas discharged from internal combustion engines of automobiles has also been rapidly increasing. Particularly, various substances included in exhaust gas from diesel engines cause pollution, and thus have an increasingly serious impact on the global environment today.

Under such circumstances, various exhaust gas treating apparatuses have been conventionally proposed and put into practice. In a typical exhaust gas treating apparatus, a casing made of, for example, metal, is provided in the middle of an exhaust pipe connected to an exhaust gas manifold of an engine. Inside the casing, there is an exhaust gas treating body including multiple cells extending in the longitudinal direction, which cells are partitioned by cell walls. Examples of the exhaust gas treating apparatus are a catalyst carrier and an exhaust gas filter such as a diesel particulate filter (DPF). In the case of a DPF, the cells are sealed at one end in a checkered manner. As the exhaust gas passes through the cell walls and exits the exhaust gas treating body, particulates are trapped in the cell walls. Thus, the particulates can be removed from the exhaust gas. The exhaust gas treating body can be made of metal, alloy, ceramics, or the like. A representative example of an exhaust gas treating body made of ceramics is a honeycomb filter made of cordierite. In recent years and continuing, in consideration of heat resistance, mechanical strength, and chemical stability, a porous silicon carbide sintered body is used as the material of the exhaust gas treating body.

Typically, a holding seal member is provided between the exhaust gas treating body and the casing. The holding seal member prevents the exhaust gas treating body from breaking as a result of contacting the inside of the casing, which may occur while a vehicle is traveling. The holding seal member also prevents untreated exhaust gas from leaking through a gap between the casing and the exhaust gas treating body. The holding seal member also prevents the exhaust gas treating body from being displaced due to exhaust gas pressure. Furthermore, the exhaust gas treating body needs to be maintained at high temperature in order to maintain reactivity, and therefore the holding seal member is required to have a heat insulation property. In order to satisfy such requirements, there are sheet members made of inorganic fiber such as alumina fiber. Conventionally, there have been various sheet members used as holding seal members, such as those manufactured by a needling processing method, a paper making method, or the like (for example, Japanese Laid-Open Patent Application No. S60-88162).

The holding seal member is wound around at least a part of the peripheral surface of the exhaust gas treating body, except for its openings. For example, gripping parts on both ends of the holding seal member are mated to each other, and the holding seal member is integrally fixed to the exhaust gas treating body with the use of taping or the like. Then, this integrated component is put inside the casing, thereby configuring an exhaust gas treating apparatus.

The contents of Japanese Laid-Open Patent Application No. S60-88162 are incorporated herein by reference in their entirety.

### SUMMARY OF THE INVENTION

The present invention provides a sheet member and a manufacturing method thereof, an exhaust gas treating apparatus and a manufacturing method thereof and a silencing device.

An embodiment of the present invention provides a sheet member including inorganic fiber; and a first surface and a second surface that are substantially perpendicular with respect to a thickness direction of the sheet member, wherein the first surface includes a first sheet portion having a first volume density; and the second surface includes a second sheet portion having a second volume density that is higher than the first volume density.

An embodiment of the present invention provides a manufacturing method of manufacturing a sheet member including inorganic fiber and a first surface and a second surface that are substantially perpendicular with respect to a thickness direction of the sheet member, the manufacturing method including a step of preparing a first base sheet having a first volume density; a step of preparing a second base sheet having a second volume density that is higher than the first volume density; and a step of joining the first base sheet to the second base sheet.

An embodiment of the present invention provides a manufacturing method of manufacturing, by a needling processing method, a sheet member including inorganic fiber and a first surface and a second surface that are substantially perpendicular with respect to a thickness direction of the sheet member, the manufacturing method including a step of providing a raw material sheet of the inorganic fiber, including the first surface and the second surface; a step of performing needling processing on the raw material sheet from a side of the first surface and from a side of the second surface of the raw material sheet in such a manner that a density of needle traces of the first surface is lower than that of the second surface; and a step of firing the raw material sheet to form the sheet member in which the needle trace density of the first surface is lower than that of the second surface.

An embodiment of the present invention provides a manufacturing method of manufacturing a sheet member including inorganic fiber and a first surface and a second surface that are substantially perpendicular with respect to a thickness direction of the sheet member, the manufacturing method including a step of injecting, into a molding vessel, first raw material slurry including the inorganic fiber; a step of dehydrating the first raw material slurry; a step of injecting, onto the first raw material slurry that has been dehydrated, second raw material slurry including a higher binder content than that of the first raw material slurry; and a step of dehydrating the second raw material slurry.

### BRIEF DESCRIPTION OF THE DRAWINGS

Other objects, features and advantages of the present invention will become more apparent from the following detailed description when read in conjunction with the accompanying drawings, in which:

FIG. 1 is a schematic sectional view of a plane perpendicular to the longitudinal direction of an exhaust gas treating body with a conventional sheet member wound therearound;

FIG. 2 is an example of a shape of a sheet member according to an embodiment of the present invention;

FIG. 3 is a conceptual diagram illustrating the sheet member according to the embodiment of the present invention being placed into a casing together with an exhaust gas treating body;

FIG. 4 is a schematic sectional view of a plane perpendicular to the longitudinal direction of an exhaust gas treating body with a sheet member according to the embodiment of the present invention wound therearound;

FIG. 5 schematically illustrates a covered exhaust gas treating body being placed into a casing by a press-fitting method;

FIG. 6 schematically illustrates a covered exhaust gas treating body being placed into a casing by a clamshell method;

FIG. 7 schematically illustrates a covered exhaust gas treating body being placed into a casing by a winding-tightening method;

FIG. 8 schematically illustrates a covered exhaust gas treating body being placed into a casing by a sizing method;

FIG. 9 illustrates an example of the configuration of an exhaust gas treating apparatus according to an embodiment of the present invention;

FIG. 10 schematically illustrates an example of the configuration of a silencing device according to the embodiment of the present invention;

FIG. 11 is a flowchart of an adhering method for fabricating the sheet member according to an embodiment of the present invention; and

FIG. 12 is a flowchart of a simultaneous fabricating method for fabricating the sheet member according to the embodiment of the present invention.

### DESCRIPTION OF THE EMBODIMENTS

A description is given, with reference to the accompanying drawings, of an embodiment of the present invention. An embodiment of the present invention relates to a sheet member including inorganic fiber, which sheet member has first and second surfaces that are perpendicular with respect to its thickness direction, a manufacturing method of the sheet member, an exhaust gas treating apparatus including the sheet member as a holding sheet member and/or a heat insulator, and a manufacturing method of the exhaust gas treating apparatus. Furthermore, an embodiment of the present invention relates to a silencing device including the sheet member as a sound absorbing material.

According to one embodiment of the present invention, a sheet member and a manufacturing method thereof are provided, which sheet member can be increased in thickness while mitigating macro wrinkles caused by the difference in peripheral lengths of the sheet member. Furthermore, according to one embodiment of the present invention, an exhaust gas treating apparatus and a manufacturing method thereof are provided, which exhaust gas treating apparatus employs the sheet member applied as a holding seal member and/or a heat insulator. Moreover, according to one embodiment of the present invention, a silencing device is provided, in which the aforementioned sheet member is applied as a sound absorbing material.

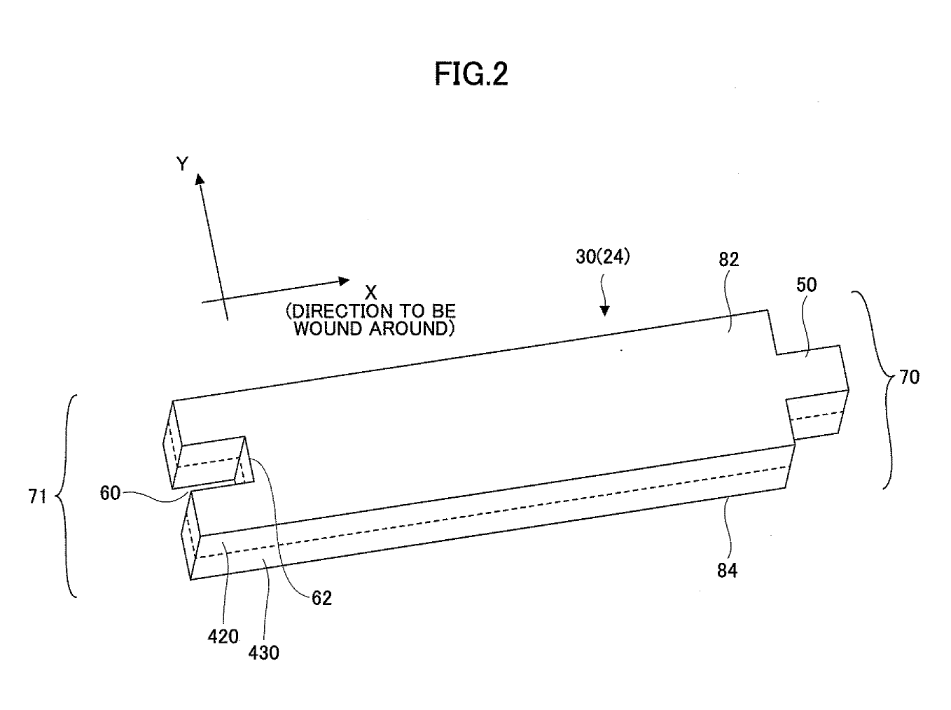

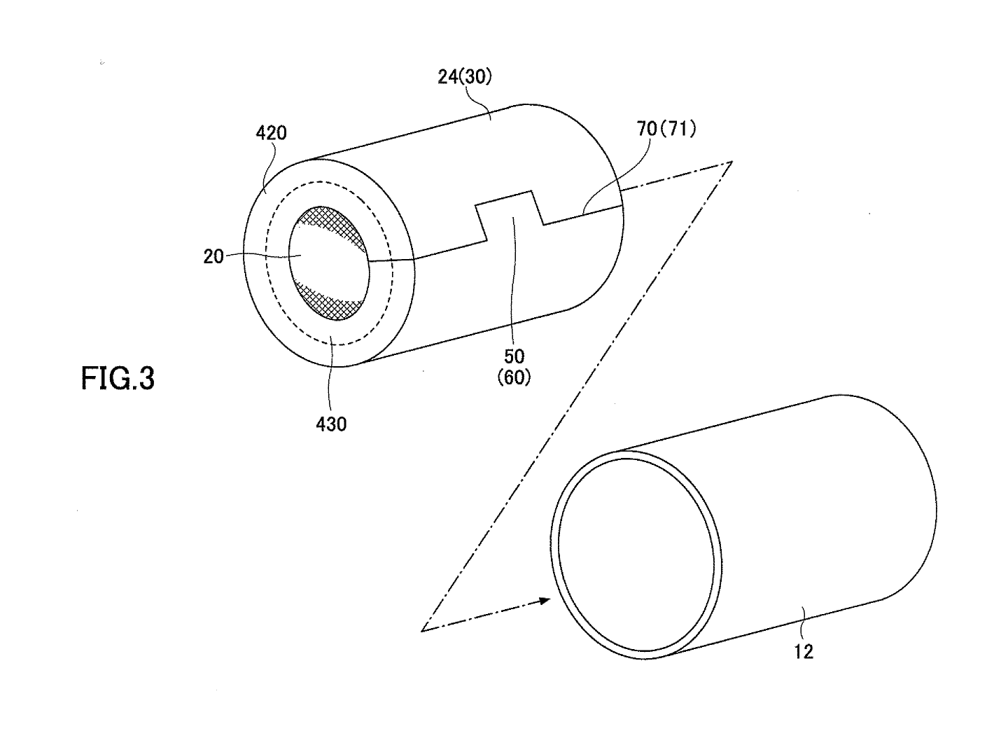

FIG. 2 illustrates a sheet member according to an embodiment of the present invention. The sheet member according to the embodiment of the present invention is not limited to that illustrated in FIG. 2. FIG. 3 is a disassembled view of an exhaust gas treating apparatus employing the sheet member according to the embodiment of the present invention as a holding seal member.

A sheet member 30 according to an embodiment of the present invention is wound around the exhaust gas treating body 20 to be used as a holding seal member 24 of an exhaust gas treating apparatus. As shown in FIG. 2, two edge faces 70 and 71 are perpendicular to the direction in which the sheet member 30 is wound (X direction). The edge faces 70 and 71 have a pair of mating parts, i.e., a mating protruding part 50 and a mating receding part 60, respectively. When the sheet member 30 is wound around the exhaust gas treating body 20, as shown in FIG. 3, the mating protruding part 50 is mated to the mating receding part 60, and the sheet member 30 is fixed to the exhaust gas treating body 20. Subsequently, the exhaust gas treating body 20 with the sheet member 30 wound therearound is pressed into a cylindrical casing 12 made of metal or the like by, for example, a press-fitting method, thus configuring an exhaust gas treating apparatus 10.

The sheet member 30 according to an embodiment of the present invention is primarily made of inorganic fiber; however, the sheet member 30 can further include binder, as described below.

The sheet member 30 according to an embodiment of the present invention has two main surfaces perpendicular to the thickness direction. The first main surface has a first volume density and the second main surface has a second volume density that is greater than the first volume density. The sheet member can include a first sheet portion having the first volume density and a second sheet portion having the second volume density, along the thickness direction.

For example, as shown in FIG. 2, the sheet member 30 according to the embodiment of the present invention has first and second main surfaces 82 and 84, which are perpendicular to the thickness direction. The sheet member 30 according to the embodiment of the present invention also has a first sheet portion 420 having a first volume density and a second sheet portion 430 having a second volume density that is greater than the first volume density. The first sheet portion 420 having the first volume density is provided on the side of the first main surface 82 of the sheet member 30. The sheet member 30 can be made by separately preparing the first sheet portion 420 and the second sheet portion 430, and then laminating these two portions onto each other. Alternatively, the sheet member 30 can be made by simultaneously or consecutively adjusting the volume densities of the first and second main surfaces of the sheet member 30, during a series of steps in the process of manufacturing the sheet member.

The volume density herein refers to the weight of the sheet member per unit volume. The volume density of the main surface of the sheet member is measured according to the following method.

First, a cutting machine or the like is used to cut out the sheet member into a size of 50 mm×50 mm. Next, a utility knife is used to cut the sheet member in a direction substantially perpendicular to the thickness direction of the sheet member at a position that is approximately at a depth of 20% under the first and second main surfaces, thereby obtaining samples of both main surfaces. Next, the weight W (g) and the thickness T (cm) of each cut out sample are measured. The thickness of each sample is measured in a status where a plumb with a surface area of approximately 3.1 cm² (diameter of 20 mmø) and a weight of 31 g is provided in the center of the sample (10 g/cm²). Based on the measurement results, the volume densities of both main surfaces are calculated with the following formula:

volume density (g/cm³)=sample weight W/(sample thickness T×5 cm×5 cm). This measurement is performed for a total of three times at different portions of the sheet member. The average value of the obtained values for each main surface is determined as the volume density (g/cm³) of each main surface of the sheet member.

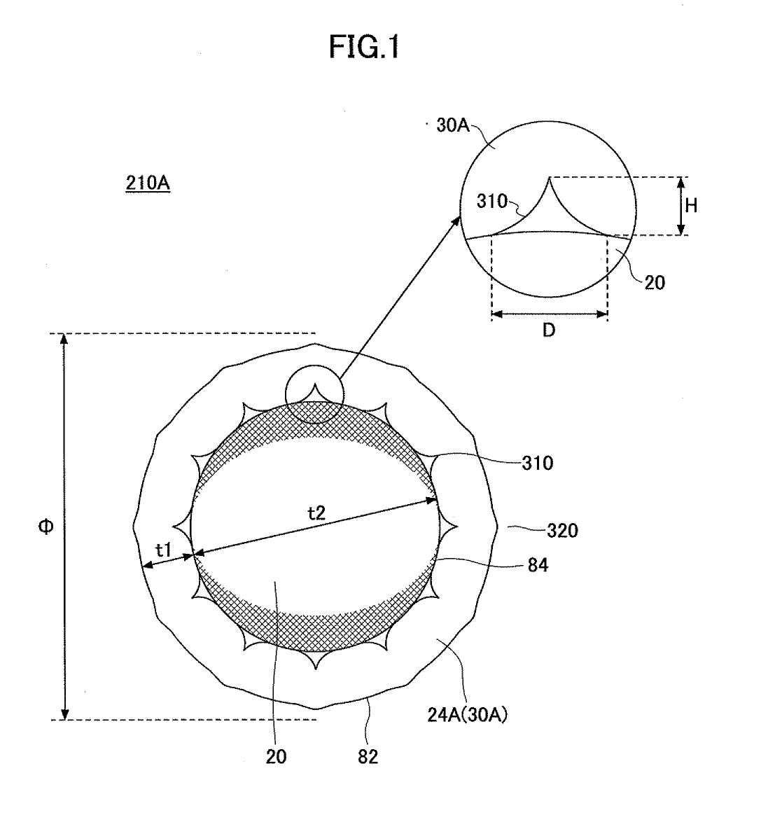

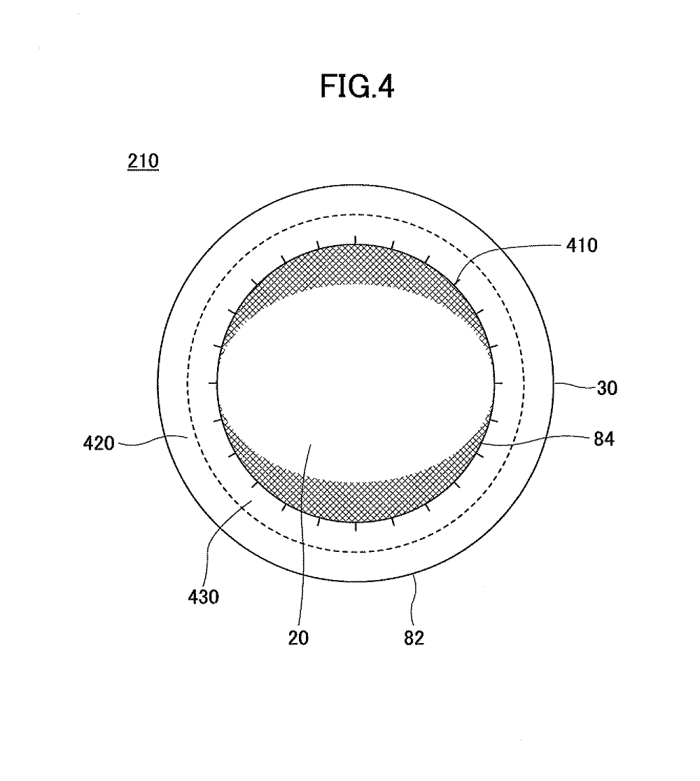

Next, the characteristic effects attained with the sheet member 30 according to the embodiment of the present invention having the above configuration are described with reference to FIGS. 1 and 4. FIG. 1 is a schematic sectional view of a plane perpendicular to the longitudinal direction of the exhaust gas treating body 20 with the conventional sheet member 30A wound therearound (hereinafter, “covered exhaust gas treating body 210A”). FIG. 4 is a similar schematic sectional view of a plane of the exhaust gas treating body 20 with the sheet member 30 according to the embodiment of the present invention wound therearound (hereinafter, “covered exhaust gas treating body 210”).

As shown in FIG. 1, when the sheet member 30A is wound around the exhaust gas treating body 20, there is usually a difference in peripheral lengths L (=LO−LI), which is the difference between the outer periphery (LO) and the inner periphery (LI) of the sheet member 30A. For this reason, many macro wrinkles 310 are formed on the inner periphery side of the sheet member 30A. The term macro wrinkle herein refers to a wrinkle having a length (height) H exceeding 2 mm as viewed in a cross-section perpendicular to the longitudinal direction of the covered exhaust gas treating body, or a wrinkle having a width D exceeding 3 mm. Accordingly, it is to be noted that the term macro wrinkle does not include microscopic wrinkles that are less than or equal to 2 mm in height and less than or equal to 3 mm in width. The impact of the difference in peripheral lengths of the sheet member becomes particularly significant as the thickness of the sheet member 30A increases. Therefore, if a thick sheet member is wound around the exhaust gas treating body 20, the height H or the width D of each macro wrinkle 310 being formed on the inner periphery will increase and/or the number of macro wrinkles 310 will increase.

If many macro wrinkles 310 are formed in the sheet member 30A, the maximum diameter Φ of the covered exhaust gas treating body 210A will become larger than the desired value P (P=2×t1+t2, where the thickness of the holding seal member is t1 and the diameter of the exhaust gas treating body is t2). Hence, it will become difficult to fit the covered exhaust gas treating body 210A inside the casing 12. Even if the covered exhaust gas treating body 210A can fit inside the casing, the outer periphery of the sheet member 30A will have the protruding parts 320 caused by the macro wrinkles 310, and compressive stress will be locally and intensively applied to the protruding parts 320. Consequently, inorganic fiber at these parts will break, thus reducing the holding ability of the sheet member 30A.

The sheet member 30 according to an embodiment of the present invention is different from the conventional technology in that it has at least two kinds of portions along the thickness direction, i.e., the first sheet portion 420 and the second sheet portion 430. The volume density of the first sheet portion 420 is less than the volume density of the second sheet portion 430. The sheet member 30 is wound around the exhaust gas treating body 20 in such a manner that the first main surface 82 is the outer periphery. In FIGS. 1, 3, and 4, for the purpose of clarification, the boundary between the first sheet portion 420 and the second sheet portion 430 is indicated with a dashed line; however, in an actual sheet member, the boundary is rarely as clear as illustrated, unless there is an adhesive layer as described below.

Generally, a sheet member with a low volume density is more stretchable in the direction in which it is wound (the X direction in FIG. 2), than a sheet member with a high volume density. Accordingly, if the sheet member 30 is wound around the exhaust gas treating body 20 in such a manner that the first main surface 82 including the first sheet portion 420 having a lower volume density is on the outer periphery, it will be possible to mitigate the macro wrinkles 310, which are caused by the difference in peripheral lengths. This is because the outer periphery of the sheet member 30, which is stretchable in the direction that sheet member 30 is wound (X direction), stretches in such a manner as to mitigate the impact of the difference in peripheral lengths between the outer periphery and the inner periphery. As shown in FIG. 4, in a practical situation, the inner periphery of the sheet member 30 will have multiple micro wrinkles 410, which are microscopic wrinkles that are less than or equal to 2 mm in height H in the thickness direction or less than or equal to 3 mm in width D. The macro wrinkles 310 that are formed in conventional cases are significantly reduced or completely eliminated, which macro wrinkles 310 have a height H exceeding 2 mm in the thickness direction or a width D exceeding 3 mm.

As described above, when the sheet member 30 according to an embodiment of the present invention is wound around the exhaust gas treating body 20, it is possible to mitigate macro wrinkles being formed on the inner periphery caused by the difference in peripheral lengths, and thus prevent the sheet member 30 from locally increasing in thickness. Accordingly, the exhaust gas treating body 20 can easily fit in the casing. Furthermore, after the exhaust gas treating body 20 is fit in the casing, it is possible to mitigate compressive stress locally applied to the exhaust gas treating body 20, thus preventing the holding ability of the sheet member 30 from decreasing.

In the present embodiment, the volume densities of the first and second sheet portions 420 and 430 preferably fall in a range of 0.08 g/cm³ through 0.25 g/cm³. If the volume densities of the first sheet portion 420 and the second sheet portion 430 are greater than or equal to 0.08 g/cm³, the strength of the sheet member will not decrease. If the volume densities of the first sheet portion 420 and the second sheet portion 430 are less than or equal to 0.25 g/cm³, the sheet member will not become excessively stiff or significantly lose flexibility, and it will not become difficult to be wound around the exhaust gas treating body. Even if the sheet member can be wound around the exhaust gas treating body, such a sheet member will have a high restoring force (the force of returning to its state before being wound around the exhaust gas treating body), and therefore it will be difficult to mate together the ends of the sheet member and to fix the positions of the ends with the use of tape or the like.

The ratio of the thicknesses of the first sheet portion 420 to the second sheet portion 430 falls in a range of, for example, approximately 1:9 through approximately 9:1, more preferably approximately 4:6 through approximately 6:4, but not limited thereto. The thickness of the entire sheet member 30 before being wound preferably falls in a range of approximately 5 mm through approximately 20 mm.

The volume density of the entire sheet member 30 falls in a range of, for example, approximately 0.08 g/cm³ through approximately 0.25 g/cm³, but not limited thereto. The basis weight of the entire sheet member 30 falls in a range of, for example, approximately 500 g/m² through approximately 3,000 g/m², but not limited thereto. The basis weight refers to the total weight of fiber per unit area of the sheet member; however, if the sheet member includes binder, the basis weight refers to the total weight of the binder and the fiber per unit area of the sheet member.

Furthermore, if the sheet member is manufactured by the needling processing method described below, the needle trace density ratio of the first sheet portion 420 with respect to the second sheet portion 430 preferably falls in a range of approximately 0.3 through approximately 0.8. The needle trace density of both the first and second sheet portions 420 and 430 preferably falls in a range of approximately 2.0 needle traces/cm² through approximately 20.0 needle traces/cm². If either one of the needle trace densities of the first and second sheet portions 420 and 430 is greater than or equal to 2.0 needle traces/cm², the strength of the sheet member will not decrease. If either one of the needle trace densities of the first and second sheet portions 420 and 430 is less than or equal to 20.0 needle traces/cm², the volume density can be changed by increasing the needle trace density, and moreover, the sheet member will not become hard, and it will not be difficult to handle the sheet member.

The word needle trace herein refers to a trace in interlaced fiber having a maximum size of less than or equal to 3 mm² on the main surface of the sheet member manufactured by a needling processing method. Such traces in interlaced fiber are formed when a fiber interlace unit such as a needle is inserted in and pulled out from the sheet member. The needle trace density on each of the main surfaces of the base sheet is measured by the following method.

First, a cutting machine or the like is used to cut out the sheet member into a size of 50 mm×50 mm, to obtain a measuring sample. This measuring sample is impregnated with latex resin (resin amount is 5 weight % through 10 weight %), and is thoroughly dried. Next, a utility knife is used to cut the measuring sample in a direction substantially perpendicular to the thickness direction of the measuring sample at a position that is approximately at a depth of 2 mm under one of the main surfaces of the measuring sample. The new surface of the measuring sample formed in this manner is referred to as “surface A”. Next, fiber blocking the needle traces is removed with the use of tweezers. The number of needle traces formed on the surface A is counted, and the number of needle traces per unit area is calculated. This measurement is performed for a total of three times at different portions on the target main surface of the sheet member. The average value of the obtained values is determined as the needle trace density (no. of needle traces/cm²) on the target main surface of the sheet member. The needle trace density on the other main surface is also obtained by the same measurement method.

The sheet member 30 according to an embodiment of the present invention is wound around the outer periphery of the exhaust gas treating body 20 in such a manner that the side of the first main surface 82 having the first volume density is on the outer peripheral side (i.e., on the side of the casing 12). The ends of the sheet member 30 are mated to each other and fixed by taping, before being used. The exhaust gas treating body 20 having the sheet member 30 wound therearound is then provided inside the casing 12 by a press-fitting method, a clamshell method, a winding-tightening method, a sizing method, or by any other fixing method, thereby forming the exhaust gas treating apparatus 10.

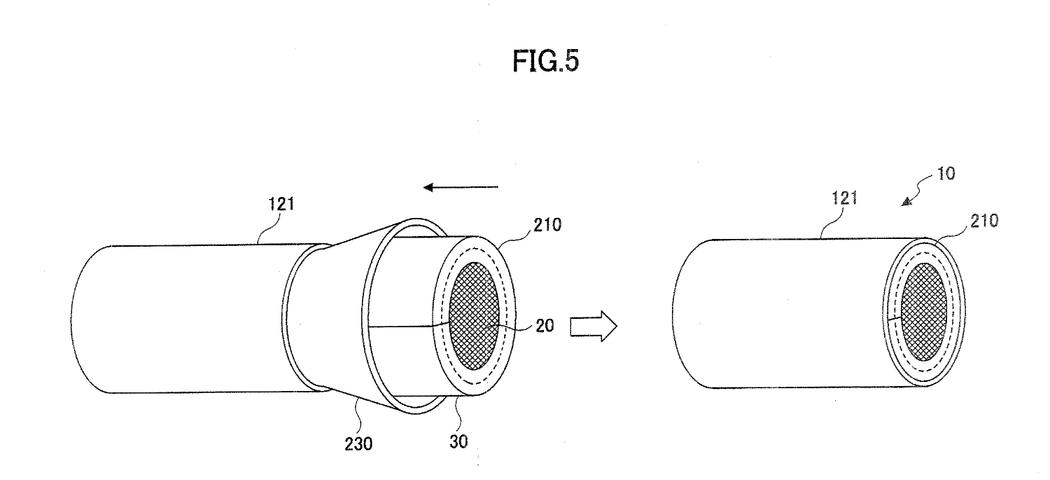

The attachment methods are described with reference to figures. FIGS. 5, 6, 7, and 8 schematically illustrate how the exhaust gas treating body 20 with the sheet member 30 wound therearound (i.e., the covered exhaust gas treating body 210) is fixed inside a casing by a press-fitting method, a clamshell method, a winding-tightening method, and a sizing method, respectively.

The press-fitting method is performed by pressing the covered exhaust gas treating body 210 into a casing 121 from one of the openings, so that the covered exhaust gas treating body 210 is fixed at a predetermined position to form the exhaust gas treating apparatus 10. To facilitate the operation of inserting the covered exhaust gas treating body 210 into the casing 121, a press-fitting jig 230 may be used. As shown in FIG. 5, the press-fitting jig 230 is shaped in such a manner that its inner hole diameter becomes smaller from one end toward the other end, and its minimum inner hole diameter is adjusted to be substantially the same size as the inner diameter of the casing 121. In this case, the covered exhaust gas treating body 210 is inserted from the side of the large inner hole diameter of the press-fitting jig 230, passes through the side of the minimum inner hole diameter, and is fixed inside the casing 121.

The sheet member according to an embodiment of the present invention is particularly effective when the covered exhaust gas treating body is fixed inside the casing by the press-fitting method. As described above, the macro wrinkles 310 (as well as the protruding parts 320) of the sheet member are mitigated. Therefore, the maximum diameter of the covered exhaust gas treating body will not deviate significantly from the desired value, so that the covered exhaust gas treating body can be inserted in the casing without difficulty.

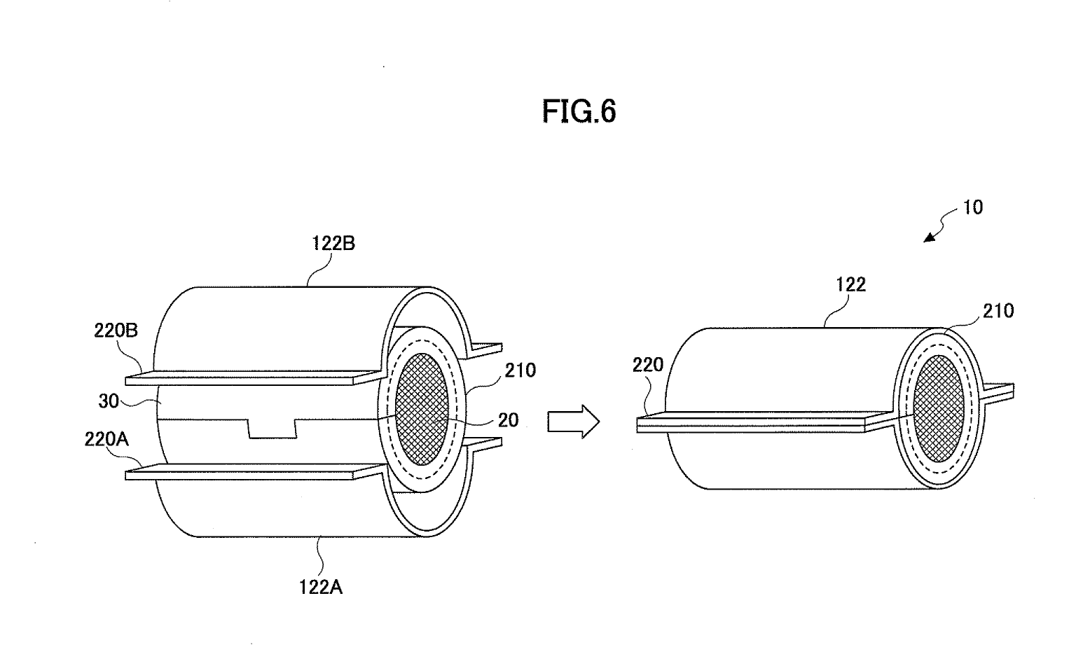

Next, the clamshell method uses a casing 122 that is divided (divided into two in the example shown in FIG. 6) into a pair of casing members 122A, 122B. The casing members 122A, 122B form the casing 122 when they are joined together facing each other. The covered exhaust gas treating body 210 is placed in one of these casing members, and then the other casing member is combined with this casing member. The casing members are then welded together at flange parts 220 (220A, 220B), thereby forming the casing 122. Accordingly, the exhaust gas treating apparatus 10 is formed, in which the covered exhaust gas treating body 210 is fixed at a predetermined position.

In the winding-tightening method, as shown in FIG. 7, a metal plate 123, which will become a casing member, is wound around the covered exhaust gas treating body 210. Then, the metal plate 123 is tightened with the use of a wire rope or the like, so that the metal plate 123 is pressed against the periphery of the covered exhaust gas treating body 210 by a predetermined contact pressure. Last, one edge of the metal plate 123 is welded together with the other edge or the portion underneath the surface of the metal plate 123, thereby forming the exhaust gas treating apparatus 10 in which the covered exhaust gas treating body 210 is fixed inside the casing 123.

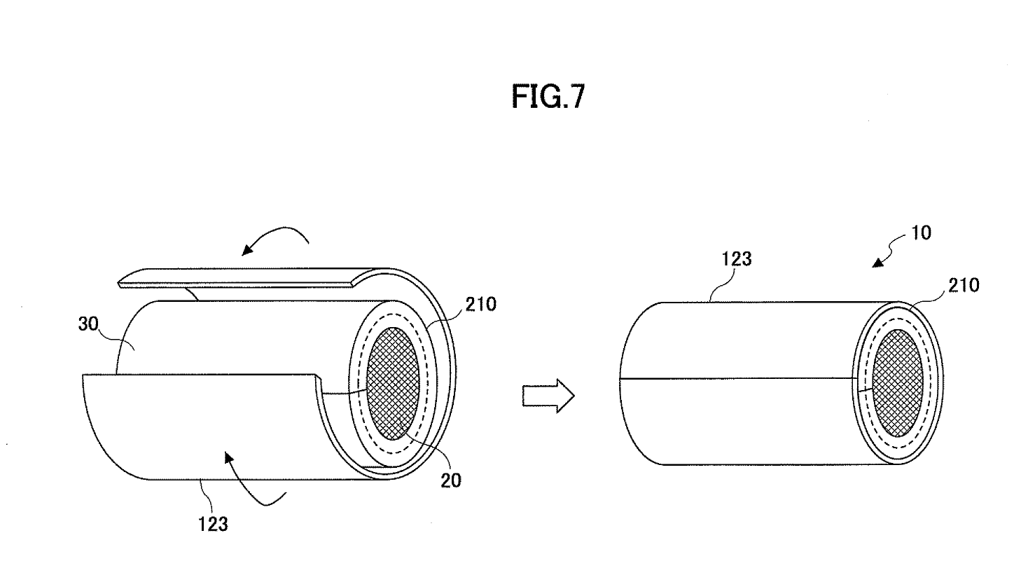

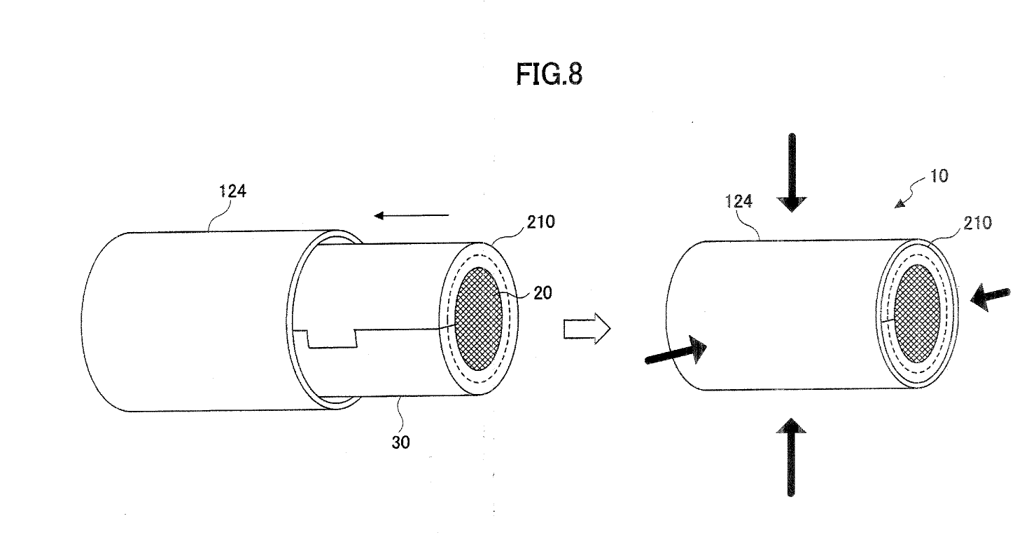

Further, in the sizing method, as shown in FIG. 8, the covered exhaust gas treating body 210 is inserted into a metal shell 124 that has an inner diameter that is greater than the outer diameter of the covered exhaust gas treating body 210. Then, with the use of a pressing machine or the like, the metal shell 124 is uniformly compressed from its outer periphery (sizing (JIS-z2500-4002)). By the sizing process, the inner diameter of the metal shell 124 can be precisely adjusted to a desired size, and the covered exhaust gas treating body 210 can be fixed at a predetermined position.

In these fixing methods, the material of the casing is usually a metal such as a heat-resistant alloy.

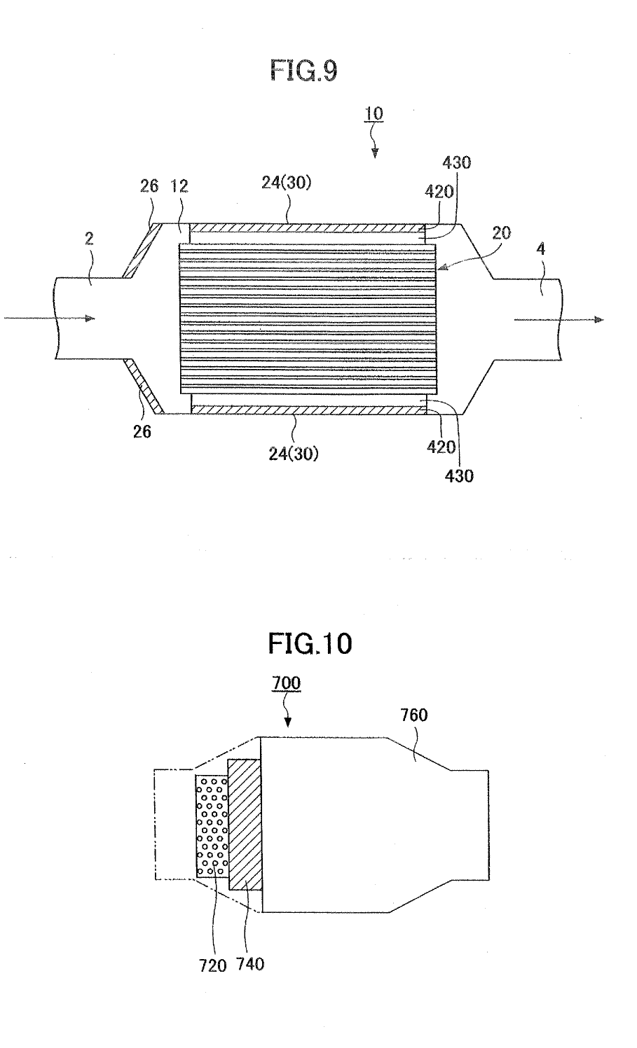

FIG. 9 illustrates an example of the configuration of the exhaust gas treating apparatus 10 according to an embodiment of the present invention. The exhaust gas treating apparatus 10 includes the exhaust gas treating body 20 having the holding seal member 24 wound around its peripheral surface, the casing 12 for accommodating the exhaust gas treating body 20, and an inlet pipe 2 and an outlet pipe 4 for the exhaust gas connected to the inlet side and the outlet side of the casing 12, respectively. In the example shown in FIG. 9, the inlet pipe 2 and the outlet pipe 4 are taper-shaped in such a manner that their diameters are enlarged at positions at which they are connected to the casing 12. However, they do not necessarily need to be taper-shaped. Furthermore, at parts of the inlet pipe 2 (the tapering part in the example shown in FIG. 9), heat insulators 26 are provided. Therefore, the heat inside the exhaust gas treating apparatus is prevented from being transferred outside via the inlet pipe 2.

In the example shown in FIG. 9, the exhaust gas treating body 20 is a catalyst carrier having opening faces corresponding to an inlet and an outlet for exhaust gas and multiple cells (or through holes) that are in a direction parallel with the gas flow. The catalyst carrier is formed with, for example, porous silicon carbide having a honeycomb structure. However, the exhaust gas treating apparatus 10 according to an embodiment of the present invention is not limited to such a configuration. For example, the exhaust gas treating body 20 can be a DPF in which the cells are sealed at one end in a checkered manner.

The holding seal member 24 is made of the sheet member 30 according to an embodiment of the present invention, which is wound around the exhaust gas treating body 20 in such a manner that the first sheet portion 420 is facing the outside (i.e., on the side of the casing 12). In such an exhaust gas treating apparatus 10, due to the effects of the above-described sheet member 30, when the sheet member 30 is wound around the exhaust gas treating body 20, macro wrinkles on the inner periphery are mitigated. Accordingly, it is possible to prevent the holding ability of the sheet member (i.e., the holding seal member 24) from decreasing, which may be caused if the inorganic fiber breaks when the sheet member 30 is fit into the casing 12.

Additionally, it is obvious to those skilled in the art that the heat insulators 26 can be made of the sheet member 30 according to an embodiment of the present invention.

Next, another application of the sheet member according to an embodiment of the present invention is described. FIG. 10 schematically illustrates an example of a silencing device including the sheet member according to an embodiment of the present invention. This silencing device is provided in the middle of an exhaust pipe of an engine of a two-wheeled vehicle or a four-wheeled vehicle. A silencing device 700 includes an inner pipe 720 (for example, made of metal such as stainless steel), an outer shell 760 covering its outside (for example, made of metal such as stainless steel), and a sound absorbing material 740 provided between the inner pipe 720 and the outer shell 760. Usually, multiple pores are provided on the surface of the inner pipe 720. With this silencing device 700, when exhaust gas flows through the inside of the inner pipe 720, noise components included in the exhaust gas can be attenuated with the sound absorbing material 740.

The sheet member 30 according to an embodiment of the present invention can be used as the sound absorbing material 740. In this case, the silencing device 700 can be fabricated by the following steps. First, the sheet member 30 is wound around and fixed to the surface of the inner pipe 720 in such a manner that the first main surface 82 of the sheet member 30 is facing the outside. Next, the inner pipe 720 with the sheet member 30 wound therearound is pressed inside the outer shell 760, thereby forming the silencing device 700. By using the sheet member 30 as the sound absorbing material 740, when the sheet member 30 is wound around the inner pipe 720, it is possible to mitigate macro wrinkles on the inner peripheral side which are caused by the difference in peripheral lengths, and also to prevent the thickness of the sheet member 30 from increasing locally. Accordingly, the inner pipe 720 can be fit inside the outer shell 760 without difficulty. Furthermore, this configuration will prevent compressive stress from being locally applied to the inner pipe 720 after being fit inside the outer shell 760, and therefore the holding ability of the sheet member 30 is prevented from decreasing.

There are two representative methods of fabricating the sheet member 30 according to an embodiment of the present invention having two main surfaces with different volume densities; namely, an adhering method and a simultaneous fabricating method.

FIG. 11 is a flowchart of the adhering method for fabricating the sheet member 30 according to an embodiment of the present invention. In this method, two base sheets having different volume densities are manufactured separately. Then, these base sheets are laminated and joined to each other, thereby fabricating a sheet member having two kinds of sheet portions having different volume densities.

First, in step S100, a first base sheet having a first volume density is fabricated. The first base sheet is fabricated by, for example, a needling processing method or a paper making method, as described below. It is to be noted that the word needling processing method herein refers to any method of manufacturing a sheet member including a needling processing step in which a fiber interlace unit such as a needle is inserted in and pulled out from the sheet member. Furthermore, it is to be noted that the word paper making method herein refers to a method of manufacturing a sheet member, including the steps of disintegrating the fiber, slurrying, molding, and compression drying.

Next, in step S110, a second base sheet having a second volume density is fabricated. Similar to the first base sheet, the second base sheet is fabricated by a needling processing method or a paper making method. The manufacturing methods of the first base sheet and the second base sheet can be the same or different. That is, when the first base sheet is manufactured by the needling processing method, the second base sheet can be manufactured by the needling processing method or the paper making method. The same applies to when the first base sheet is manufactured by the sheet paper method.

Next, in step S120, the first base sheet and the second base sheet having different volume densities are laminated and joined to each other. The base sheets can be joined together by adhering them to each other via an adhesive layer such as double-sided adhesive tape or by sewing them together. The method of joining them via an adhesive layer can be performed by directly joining together the base sheets via the adhesive layer, or by the following method. Specifically, a thermoplastic film (for example, PE film, split fiber cloth, or the like) is heat bonded onto one of the main surfaces of each base sheet at a temperature of 140° C., and double-sided adhesive tape, an adhesive agent, or the like is applied on this film to join together the base sheets. An acrylic adhesive, acrylate latex, or the like can be used as the adhesive agent. The thickness of the double-sided adhesive tape, the adhesive agent, and the thermoplastic film is not particularly limited; for example, the thickness can fall in a range of approximately 0.02 mm through approximately 0.20 mm.

The word adhesive layer herein refers to a layer of double-sided adhesive tape, an adhesive agent, or the like, provided at the interface of the two base sheets in order to join together the base sheets. If a thermoplastic film is interposed as described above, this film will also be included in the adhesive layer. Accordingly, if the thermoplastic film is interposed as described above, the thickness of the adhesive layer will be the thickness of the thermoplastic film×2+the double-sided adhesive tape (or the adhesive agent). The thickness of the adhesive layer falls in a range of, for example, approximately 0.02 mm through approximately 0.6 mm.

With these steps, the sheet member according to an embodiment of the present invention is fabricated by the adhering method.

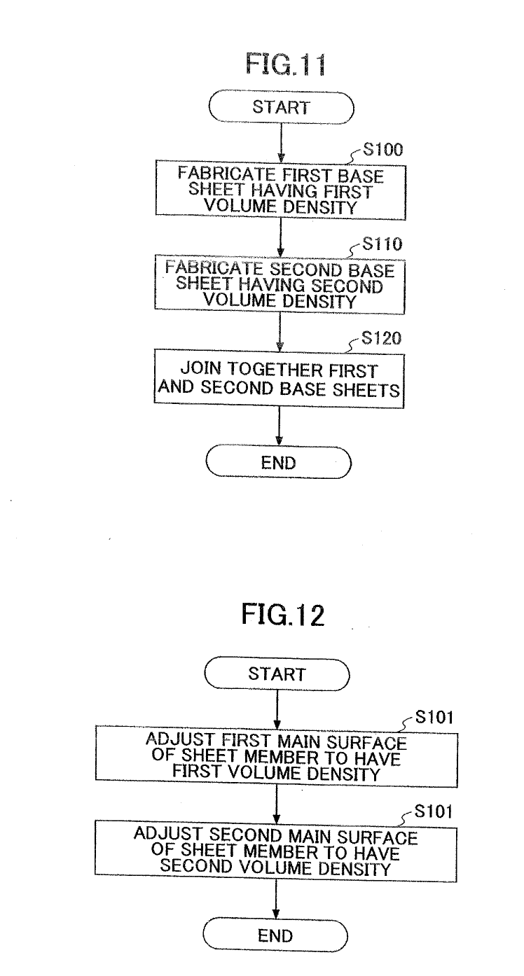

FIG. 12 is a flowchart of the simultaneous fabricating method for fabricating the sheet member 30 according to an embodiment of the present invention. This method is different from the aforementioned method of separately preparing the sheet members. In this method, two main surfaces having different volume densities are usually formed simultaneously or consecutively by adjusting the volume densities of the first and second main surfaces of the sheet member in a series of steps.

In step S200, the first main surface of the sheet member is adjusted to have a first volume density.

In step S210, the second main surface, which is on a side of the sheet member opposite to the first main surface, is adjusted to have a second volume density.

Accordingly, the sheet member according to an embodiment of the present invention is completed. This step can be performed at the same time as step S200, or after step S200. That is, the first main surface having the first volume density and the second main surface having the second volume density can be simultaneously formed on both main surfaces of the sheet member, or one of the main surfaces of the sheet member can be adjusted to have the first volume density and then the other one of the main surfaces can be adjusted to have the second volume density.

Usually, the raw material sheet used as the base of this sheet member is fabricated by a needling processing method, a paper making method, or the like. In this case, each of the base sheets do not need to be prepared separately and a single manufacturing device can be used, and therefore the manufacturing process can be simplified.

In the simultaneous fabricating method, it is also possible to perform both the needling processing method and the paper making method. For example, the sheet portion having the first volume density can be manufactured first by the needling processing method, and then, on top of this base sheet, the sheet portion having the second volume density can be manufactured by the paper making method, to thereby fabricate the sheet member according to an embodiment of the present invention having two main surfaces with different volume densities. However, unlike the case of employing either one of the needling processing method and the paper making method, it is obvious that the above advantages cannot be attained with this method.

A description is given below of specific examples of manufacturing the sheet member according to an embodiment of the present invention by the adhering method and the simultaneous fabricating method. The following describes an example of a sheet member including a mixture of alumina and silica as inorganic fiber. The fiber material is not limited thereto; for example, the fiber material can be either one of alumina or silica. It is also possible to use another kind of inorganic fiber.

### <Adhering Method 1>

As described above, in this method, at least two base sheets having different volume densities need to be prepared first. Each base sheet is fabricated by a needling processing method including steps of preparing a precursor, a blowing process, needling processing, firing, and impregnating with binder.

(Precursor Preparing Step)

Silica sol is added to a basic aluminum chloride aqueous solution in which the aluminum content is 70 g/l and the atom ratio is Al/Cl=1.8, so that the composition ratio of alumina silica becomes for example, approximately 60 through 97. approximately 40 through 3, thereby preparing the precursor of inorganic fiber. Particularly, the composition ratio of alumina:silica is more preferably approximately 70 through 97: approximately 30 through 3. If the relative proportion of alumina is less than approximately 60%, the composition ratio of the mullite, which is generated from alumina and silica, will decrease. Accordingly, the completed base sheet will tend to have high heat conductivity and reduced heat insulating properties. On the other hand, if the relative proportion of alumina exceeds approximately 97%, the flexibility of the inorganic fiber will decrease.

(Blowing Process Step)

Next, an organic polymer such as polyvinyl alcohol is added to this precursor of alumina fiber. Subsequently, this liquid is concentrated to prepare a spinning solution. This spinning solution is used in a spinning operation performed by a blowing process.

The blowing process is a spinning method performed with the use of airflows blown out from air nozzles and spinning solution flows pressed out from spinning solution supplying nozzles. The gas flow speed from slits of each air nozzle is usually 40 m/s through 200 m/s. The diameter of each spinning solution supplying nozzle is usually approximately 0.1 mm through approximately 0.5 mm, and the liquid amount per spinning solution supplying nozzle is usually approximately 1 ml/h through approximately 120 ml/h, more preferably approximately 3 ml/h through approximately 50 ml/h. Under such conditions, the spinning solution pressed out from the spinning solution supplying nozzles will be sufficiently extended without turning into a spray form (mist form), and the fibers will not be deposited onto each other. Accordingly, by optimizing the spinning conditions, it is possible to form a uniform precursor with a narrow fiber diameter distribution.

The average diameter of the alumina fibers is not particularly limited; it is possible to use alumina fibers having an average diameter of, for example, approximately 3 μm through approximately 10 μm.

The average diameter of fibers was measured by the following method. First, the alumina fibers were put in a cylinder, and crushed by applying a pressure of 20.6 MPa. Next, these samples were placed on a sifting screen. The sifted samples were used as specimens to be observed with an electron microscope. Gold or the like was vapor deposited on the surfaces of these specimens. Then, an electron microscope photograph of the specimens was taken, at a magnification ratio of approximately 1,500. The diameters of at least 40 fibers were measured from the photograph. This operation was repeated for five sets of samples, and the average measurement value was determined to be the average diameter of the fibers.

(Needling Processing Step)

The precursors that have undergone the spinning process are laminated to each other so that a raw material sheet is fabricated. Then, needling processing is performed on the raw material sheet. A needling device is usually used for the needling processing.

Generally, a needling device includes a needle board capable of reciprocating (usually up and down) in the direction in which needles are inserted in and pulled out from the raw material sheet, and a pair of supporting plates disposed on the side of the top main surface and on the side of the bottom main surface of the raw material sheet. The needle plate has multiple needles to be inserted in the raw material sheet, which needles are arranged at a density of, for example, approximately 25 needles/100 cm² through 5,000 needles/100 cm². Each supporting plate has multiple through holes for the needles. In a state where the pair of supporting plates is pressed against both sides of the raw material sheet, the needle board is moved toward and away from the raw material sheet. Accordingly, the needles are inserted in and pulled out from the raw material sheet, and multiple needle traces are formed in the interlaced fibers. The needling device can further include a conveying unit for conveying the raw material sheet in a certain direction (for example, a direction substantially parallel with the main surfaces of the raw material sheet) at a certain conveying speed (for example, approximately 1 mm/s through 20 mm/s). In this case, it will be possible to perform the needling processing while the raw material sheet is moving at a certain speed. Therefore, it will not be necessary to perform the operation of moving the raw material sheet every time the needle board is compressed against the raw material sheet.

In another configuration, the needling device can include a set of two needle boards. Each needle board has a corresponding support plate. The two needle boards are respectively disposed on the top surface and the bottom surface of the raw material sheet, so that the raw material sheet is held by the supporting plates on both sides. The needles on one of the needle boards are arranged in such a manner that their positions do not coincide with those on the other needle board during the needling processing. Furthermore, each of the support plates has multiple through holes that are arranged in consideration of the positions of the needles on each of the needle boards, so that the needles do not abut the support plate when the needling processing is performed from both sides of the raw material sheet. Such a device can be used to sandwich the raw material sheet from both sides with the two supporting plates and perform the needling processing from both sides of the raw material sheet with the two needle boards (hereinafter, such needling processing is particularly referred to as “double needling processing”). With such a method of inserting and pulling out the needles, the process time can be reduced.

(Firing Step)

Next, the raw material sheet formed by the above steps is heated from normal temperature, and is continuously fired at a maximum temperature of approximately 1,250° C. for approximately 0.5 hour through approximately 2 hours to form a base sheet having a desired volume density.

(Binder Impregnation Step)

According to need, a binder impregnation process can be performed on the base sheet to impregnate the base sheet with binder such as organic resin. By doing so, the bulk of the base sheet can be reduced. Furthermore, fibers can be further prevented from separating from the base sheet. However, the binder impregnation step does not necessarily need to be performed at this stage. For example, the binder impregnation step can be performed after the two base sheets are joined together (after step S120 in FIG. 11).

In the impregnation step, the impregnation amount of the binder preferably falls in a range of approximately 1.0 weight % through approximately 10.0 weight %. If the amount is greater than or equal to approximately 1.0 weight %, the effect of preventing inorganic resin from separating from the base sheet will not decrease. If the amount is less than or equal to approximately 10.0 weight %, the amount of organic elements will not increase, which organic elements are discharged when the exhaust gas treating apparatus is used.

An organic binder can be used as the binder, for example, epoxy resin, acrylic resin, rubber resin, styrene resin, or the like. For example, acrylic (ACM) resin, acrylonitrile-butadiene rubber (NBR) resin, styrene-butadiene rubber (SBR) resin, or the like, can be used.

With the use of water dispersions prepared with such binder and water, the base sheet is impregnated with the binder by spray application. Excessive solid matter and moisture, which are added into the base sheet due to this process, are removed as follows.

The excessive solid matter is removed by a suction method with the use of a suction device, for example, a vacuum pump. The excessive moisture is removed by heating the base sheet at a temperature of approximately 90° C. through approximately 160° C. and/or by applying pressure to the base sheet with a pressure of approximately 40 kPa through approximately 100 kPa.

Two base sheets having different volume densities are fabricated by performing the above-described steps. Generally, the density of needle traces in the sheet member is correlated with the volume density of the sheet member. The higher the density of needle traces in the sheet member, the higher the volume density of the sheet member. In the needling processing method, the volume density of the sheet can be adjusted by changing the speed of raising/lowering the needle board having needles arranged at a certain density, and by changing the speed of sending out the sheet.

Next, the two base sheets having different volume densities are laminated to each other and then joined together by the aforementioned method (with the use of double-sided adhesive tape or an adhesive, or by sewing them together), thereby forming the sheet member according to an embodiment of the present invention.

### <Adhering Method 2>

Another example of the adhering method is the paper making method, used for fabricating each base sheet. In the paper making method, two base sheets having different volume densities are fabricated by the steps of disintegrating the fiber, slurrying, molding, and compression drying.

(Disintegrating the Fiber)

First, a fiber-disintegrating process of disintegrating the inorganic fiber is performed. The fiber-disintegrating process is performed by only a dry type fiber-disintegrating process or by a two-stage process including a dry type fiber-disintegrating process and a wet type fiber-disintegrating process. In the dry type fiber-disintegrating process, a device such as a feather mill or the like is used to disintegrate the fiber of the raw material fiber. In the wet type fiber-disintegrating process, flocculent fiber formed as a result of the aforementioned dry type fiber-disintegrating process is put into a wet type fiber-disintegrating device, and the fiber is disintegrated further. The wet type fiber-disintegrating process is performed by using a wet type fiber-disintegrating device such as a pulper or the like. Raw material fiber with disintegrated fiber is formed by such a fiber-disintegrating method.

(Slurrying Step)

Next, this raw material fiber is put into an agitator, and is agitated for, for example, 1 through 5 minutes, so that its weight becomes approximately 1 weight % through approximately 2 weight % with respect to water. Next, in this liquid, an organic binder is added by approximately 4 weight % through approximately 8 weight %, and the liquid is agitated for approximately 1 through 5 minutes. Then, in this liquid, an inorganic binder is added by approximately 0.5 weight % through approximately 1.0 weight %, and the liquid is agitated for approximately 1 through 5 minutes. Furthermore, in this liquid, a flocculating agent is added by approximately 0.5 weight %, and the liquid is agitated for a maximum of approximately two minutes, thereby preparing raw material slurry.

As the inorganic binder, for example, alumina sol and/or silica sol or the like are used. As the organic binder, for example, a rubber material, a water-soluble organic high-molecular compound, a thermoplastic resin, a thermoset resin, or the like is used. As the flocculating agent, for example, Percol 292 (Ciba Specialty Chemicals K.K.) or the like is used.

(Molding Step)

Next, the resultant raw material slurry is put in a molding vessel of a desired shape to be molded into a base sheet raw material, and is then dehydrated. Usually, at the bottom of the molding vessel, a filtering mesh (of a mesh size of, for example, 30 meshes) is provided. The moisture in the raw material slurry put in the molding vessel is discharged through this filtering mesh. Accordingly, by using such a molding vessel, it is possible to mold and dehydrate the base sheet raw material at the same time. Furthermore, according to need, the moisture can be forcibly suctioned via a filtering mesh from beneath the molding vessel with the use of a suction pump, a vacuum pump, or the like.

(Compression Drying Step)

Next, the resultant base sheet raw material is removed from the molding vessel. The base sheet raw material is compressed with a pressing machine or the like so that its thickness is reduced by approximately 0.3 times through approximately 0.5 times the original thickness, and at the same time, the base sheet raw material is heated and dried at a temperature of, for example, approximately 90° C. through approximately 150° C. for approximately 5 minutes through approximately 1 hour, thereby forming a base sheet.

The resultant base sheet can undergo a binder impregnation step as in the adhering method 1. However, as described above, in the case of the adhering method, such a binder impregnation step can be performed after the two base sheets have been joined together.

Two base sheets having different volume densities are formed by performing the above-described steps In the paper making method, in the compression drying step, the volume density of the base sheet can be changed by changing the compressibility of the base sheet.

Next, the two base sheets having different volume densities are laminated to each other and then joined together by the aforementioned method (with the use of double-sided adhesive tape or an adhesive, or by sewing them together), thereby forming the sheet member according to an embodiment of the present invention.

### <Simultaneous Fabricating Method 1>

In the simultaneous fabricating method, it is possible to employ the needling processing method and the paper making method. In a simultaneous fabricating method 1, a simultaneous fabricating method based on the needling processing method is described.

In this method, a sheet member is basically fabricated by the same steps as those of the above-described adhering method 1. In particular, the above-described double needling processing step is preferably performed. However, in this simultaneous fabricating method 1, the needle board, which is used in the needling processing step where needles are inserted in and pulled out from the raw material sheet, is different from that of the adhering method 1. Specifically, between the two needle boards used in the double needling processing, which needle boards are provided on both main surfaces of the raw material sheet, the needles provided on at least one needle board have lengths that are shorter than the thickness of the raw material sheet (for example, the lengths are half the thickness of the raw material sheet). Therefore, when the needle board is pressed against the raw material sheet, the needles do not reach the other side of the raw material sheet. The densities at which the needles are arranged on the two needle boards can be different or the same. However, if the lengths of the needles are shorter than the thickness of the raw material sheet on both of the needle boards, the densities at which the needles are arranged on the two needle boards need to be different. Otherwise, as a result, both of the main surfaces of the raw material sheet will have the same needle trace density.

With the use of two of these needle boards, the needles are inserted in and pulled out from both sides of the raw material sheet. Accordingly, it is possible to simultaneously form two portions having different needle trace densities and different volume densities along the thickness direction of the raw material sheet.

The steps after firing are the same as the adhering method 1; however, as a matter of course, in this method, it is needless to perform the step of joining together the two base sheets. Moreover, in the above description, the double needling processing is employed to simultaneously perform the needling processing on both main surfaces; however, it is obvious that in the simultaneous fabricating method 1, instead of performing the double needling processing, the needling processing can be sequentially performed for one main surface after the other.

### <Simultaneous Fabricating Method 2>

In this method, the paper making method is employed to form two main surfaces having different volume densities in a single sheet member by performing a series of steps. Also, in this method, a sheet member is basically fabricated by the same steps as those of the above-described adhering method 2. However, in this method, the step of putting the raw material slurry in a molding vessel of a desired shape and molding the sheet raw material is different from that of the adhering method 2. Specifically, in this method, after putting first raw material slurry in the molding vessel and performing dehydration and before removing this sheet raw material (that is, in a semi-dry state), second raw material slurry, which has a greater amount of binder content than that of the first raw material slurry, is put on the dehydrated sheet raw material (hereinafter, “first sheet raw material”). Next, the moisture included in the second raw material slurry is discharged from the bottom of the molding vessel via the first sheet raw material and the filtering mesh to dehydrate the second raw material slurry, thereby preparing a second sheet raw material. As described above, according to need, the moisture can be forcibly suctioned from beneath the molding vessel.

By performing such steps, a sheet raw material is formed, in which the second sheet raw material is directly laminated to the first sheet raw material. In this method, by changing the amounts of binder included in the first raw material slurry and the second raw material slurry, the volume densities of the first sheet raw material and the second sheet raw material can be controlled. Accordingly, by subsequently undergoing the above-mentioned compression drying step, a sheet member according to an embodiment of the present invention can be formed.

In the four types of manufacturing methods described above, the example of the sheet member according to an embodiment of the present invention has two different volume densities along its thickness direction. However, the present invention is not limited to the above-described configurations; it is obvious that the sheet member can have three or more different volume densities along its thickness direction. A sheet member with such a configuration can be easily fabricated by laminating together three or more base sheets having different volume densities in the adhering method 1 and the adhering method 2, or by adding third raw material slurry onto the second sheet raw material in the simultaneous fabricating method 2.

### PRACTICAL EXAMPLES

The effects of an embodiment of the present invention are described in the following practical examples.

To verify the effects of an embodiment of the present invention, sheet members according to the embodiment of the present invention were fabricated by the above-mentioned adhering method 1, and were tested by being wound around a cylinder. The sheet members were fabricated by the following procedures.

### Practical Example 1

Silica sol was added to a basic aluminum chloride aqueous solution in which the aluminum content is 70 g/l and the atom ratio is Al/Cl=1.8, so that the composition ratio of alumina fiber became Al₂O₃:SiO2=72:28. Next, an organic polymer such as polyvinyl alcohol was added to this precursor of alumina fiber. Then, this liquid was concentrated to prepare a spinning solution. This spinning solution was used in a spinning operation performed by a blowing process. Subsequently, the precursors of alumina fiber were folded and laminated to each other so that a raw material sheet of alumina fiber was fabricated. Next, needling processing was performed on this raw material sheet. The needling processing was performed from one side of the raw material sheet by disposing a needle board, on which needles are arranged at a density of 80 needles/100 cm², only on the side of one of the main surfaces of the raw material sheet. The lengths of the needles were longer than the thickness of the raw material sheet, and therefore the needles sufficiently penetrated the raw material sheet by compressing the needle board against one side of the raw material sheet.

Subsequently, the resultant raw material sheet was continuously fired at a temperature ranging from a normal temperature to a maximum temperature of 1,250° C. for an hour. Next, the resultant sheet member was impregnated with binder. As the binder, an acrylate latex emulsion was used, and the impregnation amount was 5 weight % with respect to the total weight.

Accordingly, a first base sheet was formed, in which the needle trace density was approximately 4.0 needle traces/cm², the volume density was 0.09 g/cm³, the basis weight was 750 g/m², and the thickness was 8.30 mm. Furthermore, the average diameter of the alumina fibers was 7.2 μm, and the minimum diameter was 3.2 μm. In all of the practical examples and comparative examples including the ones described below, the needle trace density of the base sheet was measured by the above-described method.

A second base sheet having a different needle trace density was fabricated by the same method. The second base sheet was fabricated so that it has a higher needle trace density than that of the first base sheet. Specifically, a needle board on which needles are arranged at a density of 80 needles/100 cm² was disposed on one side of the base sheet, and the needling processing was performed. In the resultant second base sheet, the needle trace density was approximately 5.7 needle traces/cm², the volume density was 0.10 g/cm³, the basis weight was 750 g/m², and the thickness was 7.48 mm. Furthermore, the average diameter of the alumina fibers was 7.2 μm, and the minimum diameter was 3.2 μm.

Next, the first base sheet and the second base sheet were adhered together via double-sided adhesive tape (having a thickness of 100 μm, manufactured by Beiersdorf AG), thereby fabricating a sheet member having a total basis weight of 1,500 g/m² and a thickness of 15.83 mm. This sheet member corresponds to practical example 1.

### Practical Example 2

The first and second base sheets were fabricated by the same method as that of practical example 1. In practical example 2, the needle density of the needle board used in the needling processing for the first base sheet was 80 needles/100 cm², and the needle trace density in the completed first base sheet was 2.7 needle traces/cm². The first base sheet had a volume density of 0.08 g/cm³, a basis weight of 750 g/m², and a thickness of 9.42 mm. Furthermore, the average diameter of the alumina fibers was 7.2 μm, and the minimum diameter was 3.2 μm. The specifications of the second base sheet were the same as those of practical example 1 (however, the thickness was 7.47 mm). The first base sheet and the second base sheet were adhered together via the above-described double-sided adhesive tape, thereby forming a sheet member having a total basis weight of 1,500 g/m² and a thickness of 16.94 mm. This sheet member corresponds to practical example 2.

### Practical Example 3

The first base sheet was fabricated by the same method as that of practical example 1. In practical example 3, the needle density of the needle board used in the needling processing for the first base sheet was 80 needles/100 cm², and the needle trace density in the completed first base sheet was 2.3 needle traces/cm². The first base sheet had a volume density of 0.08 g/cm³, a basis weight of 750 g/m², and a thickness of 9.41 mm. Furthermore, the average diameter of the alumina fibers was 7.2 μm, and the minimum diameter was 3.2 μm. The second base sheet was fabricated by the same method as that of practical example 1. In practical example 3, the needle density of the needle board used in the needling processing for the second base sheet was 80 needles/100 cm², and the needle trace density in the completed second base sheet was 7.7 needle traces/cm². The second base sheet had a volume density of 0.11 g/cm³, a basis weight of 750 g/m², and a thickness of 6.80 mm. Furthermore, the average diameter of the alumina fibers was 7.2 μm, and the minimum diameter was 3.2 μm.

The first base sheet and the second base sheet were adhered together via the above-described double-sided adhesive tape, thereby forming a sheet member having a total basis weight of 1,500 g/m² and a thickness of 16.26 mm. This sheet member corresponds to practical example 3.

### Practical Example 4

The first base sheet was fabricated by the same method as that of practical example 1. In practical example 4, the needle density of the needle board used in the needling processing for the first base sheet was 80 needles/100 cm², and the needle trace density in the completed first base sheet was 6.7 needle traces/cm². The first base sheet had a volume density of 0.10 g/cm³, a basis weight of 750 g/m², and a thickness of 7.46 mm. Furthermore, the average diameter of the alumina fibers was 7.2 μm, and the minimum diameter was 3.2 μm. The second base sheet was fabricated by the same method as that of practical example 1. In practical example 4, the needle density of the needle board used in the needling processing for the second base sheet was 80 needles/100 cm², and the needle trace density in the completed second base sheet was 13.0 needle traces/cm². The second base sheet had a volume density of 0.13 g/cm³, a basis weight of 750 g/m², and a thickness of 5.80 mm. Furthermore, the average diameter of the alumina fibers was 7.2 μm, and the minimum diameter was 3.2 μm.

The first base sheet and the second base sheet were adhered together via the above-described double-sided adhesive tape, thereby forming a sheet member having a total basis weight of 1,500 g/m² and a thickness of 13.31 mm. This sheet member corresponds to practical example 4.

### Practical Example 5

The first base sheet was fabricated by the same method as that of practical example 1. However, in practical example 5, the needle density of the needle board used in the needling processing for the first base sheet was 25 needles/100 cm², so that the needle trace density in the completed first base sheet was 1.3 needle traces/cm². The first base sheet had a volume density of 0.08 g/cm³, a basis weight of 750 g/m², and a thickness of 9.44 mm. Furthermore, the average diameter of the alumina fibers was 7.2 μm, and the minimum diameter was 3.2 μm. The second base sheet was fabricated by the same method as that of practical example 1. However, in practical example 5, the needle density of the needle board used in the needling processing for the second base sheet was 25 needles/100 cm², so that the needle trace density in the completed second base sheet was 1.7 needle traces/cm². The second base sheet had a volume density of 0.08 g/cm³, a basis weight of 750 g/m², and a thickness of 9.42 mm. Furthermore, the average diameter of the alumina fibers was 7.2 μm, and the minimum diameter was 3.2 μm.

The first base sheet and the second base sheet were adhered together via the above-described double-sided adhesive tape, thereby forming a sheet member having a total basis weight of 1,500 g/m² and a thickness of 18.91 mm. This sheet member corresponds to practical example 5.

### Comparative Example 1

The first base sheet was fabricated by the same method as that of practical example 1. In comparative example 1, the needle density of the needle board used in the needling processing for the first base sheet was 80 needles/100 cm², and the needle trace density in the completed first base sheet was 5.0 needle traces/cm². The first base sheet had a volume density of 0.10 g/cm³, a basis weight of 750 g/m², and a thickness of 7.54 mm. Furthermore, the average diameter of the alumina fibers was 7.2 μm, and the minimum diameter was 3.2 μm. The second base sheet was fabricated by the same method as that of practical example 1. The second base sheet had a volume density of 0.10 g/cm³, a basis weight of 750 g/m², and a thickness of 7.52 mm. Furthermore, the average diameter of the alumina fibers was 7.2 μm, and the minimum diameter was 3.2 μm.

The first base sheet and the second base sheet were adhered together via the above-described double-sided adhesive tape, thereby forming a sheet member having a total basis weight of 1,500 g/m² and a thickness of 15.11 mm. This sheet member corresponds to comparative example 1.

### Comparative Example 2

The first base sheet was fabricated by the same method as that of practical example 1. In comparative example 2, the needle density of the needle board used in the needling processing for the first base sheet was 80 needles/100 cm², and the needle trace density in the completed first base sheet was 5.7 needle traces/cm². The first base sheet had a volume density of 0.10 g/cm³, a basis weight of 750 g/m², and a thickness of 7.48 mm. Furthermore, the average diameter of the alumina fibers was 7.2 μm, and the minimum diameter was 3.2 μm. The second base sheet was fabricated by the same method as that of practical example 1. In comparative example 2, the needle density of the needle board used in the needling processing for the second base sheet was 80 needles/100 cm², and the needle trace density in the completed second base sheet was 2.7 needle traces/cm². The second base sheet had a volume density of 0.08 g/cm³, a basis weight of 750 g/m², and a thickness of 9.41 mm. Furthermore, the average diameter of the alumina fibers was 7.2 μm, and the minimum diameter was 3.2 μm.

The first base sheet and the second base sheet were adhered together via the above-described double-sided adhesive tape, thereby fabricating a sheet member having a total basis weight of 1,500 g/m² and a thickness of 16.94 mm. This sheet member corresponds to comparative example 2.

The needle trace density, the volume density, the basis weight, and the thickness of the first and second base sheets of each of the practical examples 1 through 5 and the comparative examples 1 and 2 are all shown in Table 1. Table 1 also includes the thickness of each sheet member including the first and second base sheets, and the needle trace density ratio of the first base sheet to the second base sheet.

TABLE 1

| | FIRST BASE SHEET | | | | SECOND BASE SHEET | | | |
|---|---|---|---|---|---|---|---|---|
| | (ON SIDE OF FIRST MAIN | | | | (ON SIDE OF SECOND MAIN | | | |
| | SURFACE OF SHEET MEMBER) | | | | SURFACE OF SHEET MEMBER) | | | |
| | NEEDLE TRACE | VOLUME | BASIS | | NEEDLE TRACE | VOLUME | BASIS | |
| | DENSITY (NEEDLE | DENSITY | WEIGHT | THICKNESS | DENSITY (NEEDLE | DENSITY | WEIGHT | THICKNESS |
| | TRACES/cm²) | (g/cm³) | (g/cm²) | (mm) | TRACES/cm²) | (g/cm³) | (g/cm²) | (mm) |
| PRACTICAL | 4.0 | 0.09 | 750 | 8.30 | 5.7 | 0.10 | 750 | 7.48 |
| EXAMPLE 1 | | | | | | | | |
| PRACTICAL | 2.7 | 0.08 | 750 | 9.42 | 5.7 | 0.10 | 750 | 7.47 |
| EXAMPLE 2 | | | | | | | | |
| PRACTICAL | 2.3 | 0.08 | 750 | 9.41 | 7.7 | 0.11 | 750 | 6.80 |
| EXAMPLE 3 | | | | | | | | |
| PRACTICAL | 6.7 | 0.10 | 750 | 7.46 | 13.0 | 0.13 | 750 | 5.80 |
| EXAMPLE 4 | | | | | | | | |
| PRACTICAL | 1.3 | 0.08 | 750 | 9.44 | 1.7 | 0.08 | 750 | 9.42 |
| EXAMPLE 5 | | | | | | | | |
| COMPARATIVE | 5.0 | 0.10 | 750 | 7.54 | 5.0 | 0.10 | 750 | 7.52 |
| EXAMPLE 1 | | | | | | | | |
| COMPARATIVE | 5.7 | 0.10 | 750 | 7.48 | 2.7 | 0.08 | 750 | 9.41 |
| EXAMPLE 2 | | | | | | | | |

| | | NEEDLE TRACE | SIZE OF | | |
|---|---|---|---|---|---|
| | THICKNESS | DENSITY RATIO OF | WRINKLES | | |
| | OF SHEET | FIRST BASE SHEET | WIDTH | HEIGHT | EVALUATION |
| | MEMBER | TO SECOND | (D) | (H) | OF MACRO |
| | (mm) | BASE SHEET | (mm) | (mm) | WRINKLES |
| PRACTICAL | 15.83 | 0.7 | 2.2 | 1.2 | NOT |
| EXAMPLE 1 | | | | | FORMED |
| PRACTICAL | 16.94 | 0.5 | 2.2 | 1.4 | NOT |
| EXAMPLE 2 | | | | | FORMED |
| PRACTICAL | 16.26 | 0.3 | 2.4 | 1.6 | NOT |
| EXAMPLE 3 | | | | | FORMED |
| PRACTICAL | 13.31 | 0.5 | 2.7 | 1.7 | NOT |
| EXAMPLE 4 | | | | | FORMED |
| PRACTICAL | 18.91 | 0.8 | 2.1 | 1.4 | NOT |
| EXAMPLE 5 | | | | | FORMED |
| COMPARATIVE | 15.11 | 1.0 | 3.1 | 2.3 | FORMED |
| EXAMPLE 1 | | | | | |
| COMPARATIVE | 16.94 | 2.1 | 3.2 | 2.5 | FORMED |
| EXAMPLE 2 | | | | | |

Next, each of the sheet members fabricated by the above-described method was tested by being wound around a cylinder (wind-around test).

In the wind-around test, each sheet member was cut out in the shape shown in FIG. 2 (total size: 295 mm in the X direction (including the mating protruding part 50), 90 mm in the Y direction; size of mating protruding part 50: 30 mm in the X direction, 30 mm in the Y direction; length from each edge in the Y direction to the mating protruding part 50: 30 mm), and this was used as a test sample. Each test sample was wound around a cylinder having an outer diameter of 80 mm (and a length of 120 mm), and both of the ends were mated to each other and fixed with tape. With the use of a caliper, the width (D) and the height (H) of each wrinkle formed on the inner periphery of the sheet member were measured as described below, to evaluate the formation of macro wrinkles. First, the five largest wrinkles formed in each sheet member were selected as measurement targets, and the width and height of each of these wrinkles were measured. Next, the values obtained by measuring the widths and heights were averaged, and the obtained averages were determined to be the width and height, respectively, of each sheet member. If the calculated width (D) of the wrinkle exceeded 3 mm, and/or if the height (H) of the wrinkle exceeded 2 mm, it was determined that macro wrinkles had been formed. Otherwise, it was determined that macro wrinkles had not been formed.

In performing the test, the test sample of each sheet member of practical examples 1 through 5 and the comparative examples 1 and 2 was wound around a cylinder in such a manner that the side of the first base sheet is on the outer peripheral side.

(Test Results)

The results of the wind-around test obtained for each of the sheet members (the sizes of the wrinkles and the determination results of macro wrinkles) are shown in Table 1. From these results, it was found that when the needle trace density of the first base sheet fell in a range of 0.3 times through 0.8 times that of the second base sheet, i.e., in the case of the sheet members of practical examples 1 through 5, macro wrinkles where not formed on the inner peripheral side of the sheet member in the wind-around test. On the other hand, when the needle trace density of the first base sheet was 1.0 times and 2.1 times that of the second base sheet, i.e., in the case of the sheet members according to comparative examples 1 and 2, macro wrinkles were formed on the inner peripheral side of the sheet member.

The sheet member according to comparative example 1 corresponds to a sheet member having uniform needle trace densities with respect to the thickness direction, as those conventionally used (i.e., the needle trace density ratio of the first base sheet with respect to the second base sheet is one). Furthermore, the sheet member according to comparative example 2 was formed by arranging the base sheets of practical example 2 in a manner opposite to that of practical example 2.

From the results of comparative examples 1 and 2, it was confirmed that the effect of mitigating macro wrinkles can be attained by winding the sheet member around the exhaust gas treating apparatus in such a manner that, among the two main surfaces of the sheet member, the main surface with a lower volume density is on the outer peripheral side.

In the sheet member of practical example 5, macro wrinkles were not formed after the test; however, the layers separated from each other at the time of the wind-around test. This is because in the sheet member according to practical example 5, the needle trace densities of the first and second base sheets are small (1.3 needle traces/cm² and 1.7 needle traces/cm², respectively), and the strength was thus insufficient at the time of winding the sheet member around the cylinder. Accordingly, assuming that the sheet member is actually used in an exhaust gas treating apparatus, the needle trace densities of both main surfaces of the sheet member are preferably greater than or equal to approximately 2.0 needle traces/cm².

The sheet member according to an embodiment of the present invention can be applied as a holding seal member of an exhaust gas treating apparatus in a vehicle, or as a sound absorbing material in a silencing device.

According to one embodiment of the present invention, a sheet member is provided, which includes inorganic fiber; and a first surface and a second surface that are perpendicular with respect to a thickness direction of the sheet member, wherein the first surface includes a first sheet portion having a first volume density; and the second surface includes a second sheet portion having a second volume density that is higher than the first volume density.

By using such a sheet member according to an embodiment of the present invention as a holding seal member of an exhaust gas treating apparatus, it is possible to mitigate macro wrinkles formed on the inner peripheral surface of the holding seal member, which macro wrinkles are caused by the difference in peripheral lengths of the sheet member.

In the sheet member according to an embodiment of the present invention, the first sheet portion and the second sheet portion can be laminated to each other in the thickness direction.

In the sheet member according to an embodiment of the present invention, the sheet member has needle traces, and a density of the needle traces of the first surface can be lower than that of the second surface. In this case, the densities of the needle traces of the first surface and the second surface both preferably fall in a range of approximately 2.0 needle traces/cm² through approximately 20.0 needle traces/cm²; and the density of the needle traces of the first surface preferably falls in a range of approximately 0.3 times through approximately 0.8 times that of the second surface.

The sheet member according to an embodiment of the present invention can be fabricated by a paper making method.

The sheet member according to an embodiment of the present invention can further include a first base sheet having the first volume density and a second base sheet having the second volume density, which base sheets are laminated to each other in the thickness direction; and an adhesive layer provided at a boundary between the first base sheet and the second base sheet.

The sheet member according to an embodiment of the present invention can further include binder.

According to an embodiment of the present invention, a manufacturing method of manufacturing a sheet member is provided, wherein the sheet member includes inorganic fiber and a first surface and a second surface that are perpendicular with respect to a thickness direction of the sheet member, the manufacturing method including a step of preparing a first base sheet having a first volume density; a step of preparing a second base sheet having a second volume density that is higher than the first volume density; and a step of joining the first base sheet to the second base sheet.

The step of joining the first base sheet to the second base sheet can include a step of joining the first base sheet to the second base sheet with an adhesive or adhesive tape.

The first base sheet or the second base sheet can be prepared by a needling processing method.

The first base sheet or the second base sheet can be prepared by a paper making method.

According to an embodiment of the present invention, a manufacturing method of manufacturing, by a needling processing method, a sheet member is provided, wherein the sheet member includes inorganic fiber and a first surface and a second surface that are perpendicular with respect to a thickness direction of the sheet member, the manufacturing method including a step of providing a raw material sheet of the inorganic fiber, including the first surface and the second surface; a step of performing needling processing on the raw material sheet from a side of the first surface and from a side of the second surface of the raw material sheet in such a manner that a density of needle traces of the first surface is lower than that of the second surface; and a step of firing the raw material sheet to form the sheet member in which the density of needle traces of the first surface is lower than that of the second surface.

According to an embodiment of the present invention, a manufacturing method of manufacturing a sheet member is provided, wherein the sheet member includes inorganic fiber and a first surface and a second surface that are perpendicular with respect to a thickness direction of the sheet member, the manufacturing method including a step of injecting, into a molding vessel, first raw material slurry including the inorganic fiber; a step of dehydrating the first raw material slurry; a step of injecting, onto the first raw material slurry that has been dehydrated, second raw material slurry including a higher binder content than that of the first raw material slurry; and a step of dehydrating the second raw material slurry.

The manufacturing method of manufacturing the sheet member according to an embodiment of the present invention can further include a step of impregnating with binder.

According to an embodiment of the present invention, an exhaust gas treating apparatus is provided, which includes an exhaust gas treating body; and a holding seal member wound around at least a part of an outer peripheral surface of the exhaust gas treating body, wherein the holding seal member is the above-described sheet member; and the holding seal member is wound around the exhaust gas treating body in such a manner that the first surface of the sheet member faces the outside.

According to an embodiment of the present invention, the first sheet portion, which has a lower volume density and higher stretchability, is provided on the outer peripheral side of the holding seal member. Therefore, even if a thick holding seal member is used, macro wrinkles formed on the inner peripheral side of the holding seal member will be mitigated, which macro wrinkles are caused by the difference in peripheral lengths of the holding seal member.

According to an embodiment of the present invention, an exhaust gas treating apparatus is provided, which includes an inlet pipe and an outlet pipe for exhaust gas; and an exhaust gas treating body disposed between the inlet pipe and the outlet pipe, wherein a heat insulator is provided on at least a part of the inlet pipe; and the heat insulator includes the above-described sheet member.

The exhaust gas treating body can be a catalyst carrier or an exhaust gas filter.

According to an embodiment of the present invention, a manufacturing method of manufacturing an exhaust gas treating apparatus is provided, wherein the exhaust gas treating apparatus includes an exhaust gas treating body and a holding seal member wound around at least a part of an outer peripheral surface of the exhaust gas treating body, the manufacturing method including a step of providing, as the holding seal member, the sheet member manufactured by the above-described manufacturing method; and a step of winding the holding seal member around the exhaust gas treating body in such a manner that the first surface of the sheet member faces the outside.

The exhaust gas treating body can be a catalyst carrier or an exhaust gas filter.

The manufacturing method of manufacturing the exhaust gas treating apparatus according to an embodiment of the present invention can include a step of placing the exhaust gas treating body, which has the holding seal member wound therearound, into a casing by a press-fitting method.

According to an embodiment of the present invention, a silencing device is provided, including an inner pipe; an outer shell covering an outer periphery of the inner pipe; and a sound absorbing material disposed between the inner pipe and the outer shell, wherein the sound absorbing material is the above-described sheet member; and the sheet member is disposed between the inner pipe and the outer shell in such a manner that the first surface faces the outside.

In such a silencing device, the first sheet portion, which has a lower volume density and higher stretchability, is provided on the outer peripheral side of the sound absorbing material. Therefore, even if a thick sound absorbing material is used, macro wrinkles formed on the inner peripheral side of the sound absorbing material will be mitigated, which macro wrinkles are caused by the difference in peripheral lengths of the sound absorbing material.

Obviously, numerous modifications and variations of the present invention are possible in light of the above teachings. It is therefore to be understood that within the scope of the appended claims, the invention may be practiced otherwise than as specifically described herein.

What is claimed is:

1. A sheet member comprising:
inorganic fiber; and
a first surface and a second surface that are substantially perpendicular with respect to a thickness direction of the sheet member, wherein:
the first surface comprises a first sheet portion having a first volume density; and
the second surface comprises a second sheet portion having a second volume density that is higher than the first volume density.

2. The sheet member according to claim 1, wherein:
the first sheet portion and the second sheet portion are laminated to each other in the thickness direction.

3. The sheet member according to claim 1, wherein:
the sheet member has needle traces; and
a density of the needle traces of the first surface is lower than that of the second surface.

4. The sheet member according to claim 3, wherein:
the densities of the needle traces of the first surface and the second surface both fall in a range of approximately 2.0 needle traces/cm² through approximately 20.0 needle traces/cm²; and
the density of the needle traces of the first surface falls in a range of approximately 0.3 times through approximately 0.8 times that of the second surface.

5. The sheet member according to claim 1, further comprising:
a first base sheet having the first volume density and a second base sheet having the second volume density, which are laminated to each other in the thickness direction; and
an adhesive layer provided at a boundary between the first base sheet and the second base sheet.

6. The sheet member according to claim 1, further comprising:
a binder.

7. A manufacturing method of manufacturing a sheet member comprising inorganic fiber and a first surface and a second surface that are substantially perpendicular with respect to a thickness direction of the sheet member, the manufacturing method comprising:
a step of preparing a first base sheet having a first volume density;
a step of preparing a second base sheet having a second volume density that is higher than the first volume density; and
a step of joining the first base sheet to the second base sheet.

8. The manufacturing method according to claim 7, wherein the step of joining the first base sheet to the second base sheet comprises a step of joining the first base sheet to the second base sheet with an adhesive or adhesive tape.

9. The manufacturing method according to claim 7, wherein the first base sheet or the second base sheet is prepared by a needling processing method.

10. The manufacturing method according to claim 7, wherein the first base sheet or the second base sheet is prepared by a paper making method.

11. A manufacturing method of manufacturing, by a needling processing method, a sheet member comprising inorganic fiber and a first surface and a second surface that are substantially perpendicular with respect to a thickness direction of the sheet member, the manufacturing method comprising:
a step of providing a raw material sheet of the inorganic fiber, the raw material sheet comprising the first surface and the second surface;
a step of performing needling processing on the raw material sheet from a side of the first surface and from a side of the second surface of the raw material sheet in such a manner that a density of needle traces of the first surface is lower than that of the second surface; and
a step of firing the raw material sheet to form the sheet member in which the density of needle traces of the first surface is lower than that of the second surface.

12. A manufacturing method of manufacturing a sheet member comprising inorganic fiber and a first surface and a second surface that are substantially perpendicular with respect to a thickness direction of the sheet member, the manufacturing method comprising:
a step of injecting, into a molding vessel, first raw material slurry comprising the inorganic fiber;
a step of dehydrating the first raw material slurry;
a step of injecting, onto the first raw material slurry that has been dehydrated, second raw material slurry comprising a higher binder content than that of the first raw material slurry; and
a step of dehydrating the second raw material slurry.

13. The manufacturing method according to claim 7, further comprising:
a step of impregnating with a binder.

14. An exhaust gas treating apparatus comprising:
an exhaust gas treating body; and
a holding seal member wound around at least a part of an outer peripheral surface of the exhaust gas treating body, wherein:
the holding seal member comprises a sheet member according to claim 1; and
the holding seal member is wound around the exhaust gas treating body in such a manner that the first surface of the sheet member faces an outside of the sheet member.

15. An exhaust gas treating apparatus comprising:
an inlet pipe and an outlet pipe for exhaust gas; and
an exhaust gas treating body disposed between the inlet pipe and the outlet pipe, wherein:
a heat insulator is provided on at least a part of the inlet pipe; and
the heat insulator comprises a sheet member according to claim 1.

16. The exhaust gas treating apparatus according to claim 14, wherein:
the exhaust gas treating body comprises a catalyst carrier or an exhaust gas filter.

17. A manufacturing method of manufacturing an exhaust gas treating apparatus comprising an exhaust gas treating body and a holding seal member wound around at least a part of an outer peripheral surface of the exhaust gas treating body, the manufacturing method comprising:
a step of providing, as the holding seal member, a sheet member manufactured by the manufacturing method according to claim 7; and
a step of winding the holding seal member around the exhaust gas treating body in such a manner that the first surface of the sheet member faces an outside of the sheet member.

18. The manufacturing method according to claim 17, wherein:
the exhaust gas treating body comprises a catalyst carrier or an exhaust gas filter.

19. A silencing device comprising:
an inner pipe;
an outer shell covering an outer periphery of the inner pipe; and
a sound absorbing material disposed between the inner pipe and the outer shell, wherein:
the sound absorbing material comprises a sheet member according to claim 1; and
the sheet member is disposed between the inner pipe and the outer shell in such a manner that the first surface faces an outside of the sheet member.
